(19) United States
(12) Patent Application Publication
(10) Pub. No.: US 2007/0004452 A1
(43) Pub. Date: Jan. 4, 2007

(54) Wireless device

(76) Inventor: Wen-Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/147,265

(22) Filed: Jun. 8, 2005

(51) Int. Cl. H04M 1/00

(52) U.S. Cl. 455/556.2

(57) ABSTRACT

A wireless device of the present invention has a wireless access device and a wireless stylus. The wireless stylus has a cursor control unit, an identification code storage unit, a mouse interface circuit, and a radio frequency transmitter. The cursor control unit is used to generate a movement signal, and the identification code storage unit is used to store temporarily identification code information. The mouse interface circuit is electrically connected with the cursor control unit and the identification code storage unit. Besides, the mouse interface circuit is used to receive the movement signal and the identification code information to output a cursor control signal and an identification code signal, by signal information processing. The radio frequency transmitter is electrically connected to the mouse interface circuit and used to transmit the cursor control signal and the identification code signal to the wireless access device by wireless communication.

### BACKGROUND OF THE INVENTION

1. Field of the Invention

The present invention relates to a wireless device, and in particular to a wireless device for receiving/transmitting an identification code signal to generate wireless communication by identification code.

2. Description of Related Art

Reference is made to FIG. 1. FIG. 1 illustrates a perspective view of a conventional laptop. The conventional laptop 10 includes a monitor 11, a keyboard 12 and a base portion 13. The keyboard 12 is positioned at the base portion 13, and a touch panel 14 is also positioned at the base portion 14. When a user's hands touch and move across the touch panel 14, the touch panel 14 transmits signal indicative of movement of users' hands to the conventional laptop 10 to control cursor on the monitor 11.

Reference is made to FIG. 2. FIG. 2 illustrates a perspective view of a conventional personal digital assistant (PDA). The conventional personal digital assistant 20 includes a housing 21, a monitor 22, a touch area 23 and a function key 24. The monitor 22 has a Chinese character input area 25, and the touch area 23 also includes Roman alphabet input area 26 as well as a number input area 27. A stylus is used to choose one of these input areas for input of Chinese characters, Roman alphabet letters, or numbers.

The touch panel 14 of the conventional laptop 10 is used to control a cursor, but users usually prefer to use a mouse. Thus, a user needs to carry a mouse and the conventional laptop 10, so a touch panel is seldom used. Besides, the conventional personal digital assistant 20 has no physical keyboard, and it is not convenient for user to input individual characters into corresponding input areas.

In view of this, a wireless stylus 30 is used to transmit cursor control signals, text information signals and key control signals to the conventional laptop 10 (as shown in FIG. 3) or the conventional personal digital assistant 20 (as shown in FIG. 4) by wireless communication technology so as to overcome the above-mentioned disadvantages. However, many wireless styluses 30 transmit information signals to the conventional laptop 10 or the conventional personal digital assistant 20 by wireless communication. These transmission signals will be respectively interrupted.

### SUMMARY OF THE INVENTION

It is an object of the present invention to disclose a wireless device, in which an identification code signal with an identification code is transmitted by a wireless stylus to wireless receiving/transmitting module of the wireless access device. The identification signal is subjected to authentication process so that the wireless access device is controlled by the wireless stylus via wireless communication.

A wireless device of the present invention includes a wireless access device having a wireless receiving/transmitting module and a wireless stylus having an identification code. The wireless stylus includes a cursor control unit, an identification code storage unit, a mouse interface circuit and a radio frequency transmitter. The cursor control unit is used to generate a movement signal, and the identification code storage unit is used to temporarily store identification code information. The mouse interface circuit is electrically connected with the cursor control unit and the identification code storage unit. Besides, the mouse interface circuit is used to receive the movement signal and the identification code information to output a cursor control signal and an identification code signal, by signal information processing. The radio frequency transmitter is electrically connected to the mouse interface circuit and used to transmit the cursor control signal and the identification code signal to the wireless access device by wireless communication.

According to the present invention, the wireless access device issues a polling session to obtain a pre-defined identification code of the wireless stylus so as to establish wireless communication. After the wireless communication is established, the user can use the wireless stylus as a conventional wireless mouse by transmitting a cursor signal to the wireless access device.

The present invention has following advantages. When the wireless access device having the wireless receiving/transmitting module cannot detect the identification code signal from the wireless stylus, the wireless access device will execute a system protection program and be in sleep mode. Additionally, when the wireless stylus with the identification code is moved away from the wireless access device for a while, the wireless access device cannot detect the identification code signal from the wireless stylus, and the wireless device will be shut down. Further, a user can awaken the wireless access device through the wireless stylus and turn on or turn off the wireless access device through the key control signals.

### BRIEF DESCRIPTION OF THE DRAWINGS

The present invention can be fully understood from the following detailed description and preferred embodiment with reference to the accompanying drawings, in which:

FIG. 1 is a perspective view showing a conventional laptop;

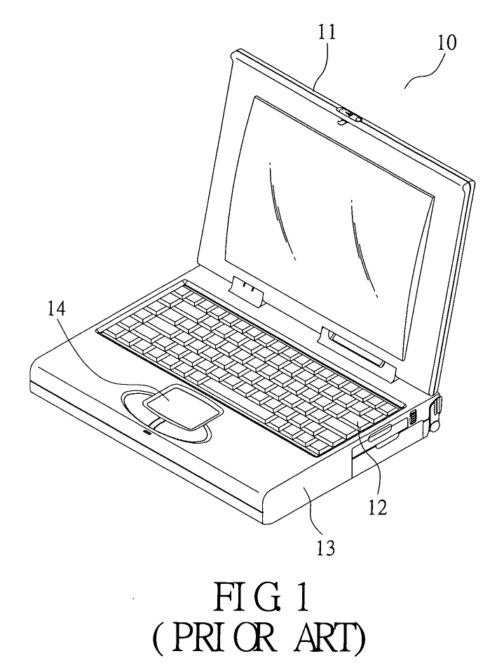

FIG. 2 is a perspective view showing a conventional personal digital assistant (PDA);

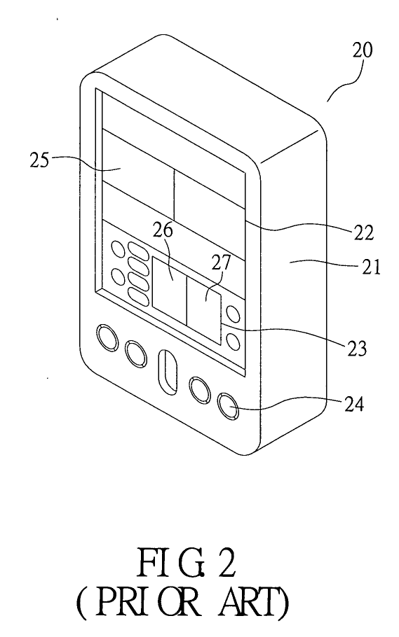

FIG. 3 schematically illustrates a wireless stylus control cursor of a conventional laptop;

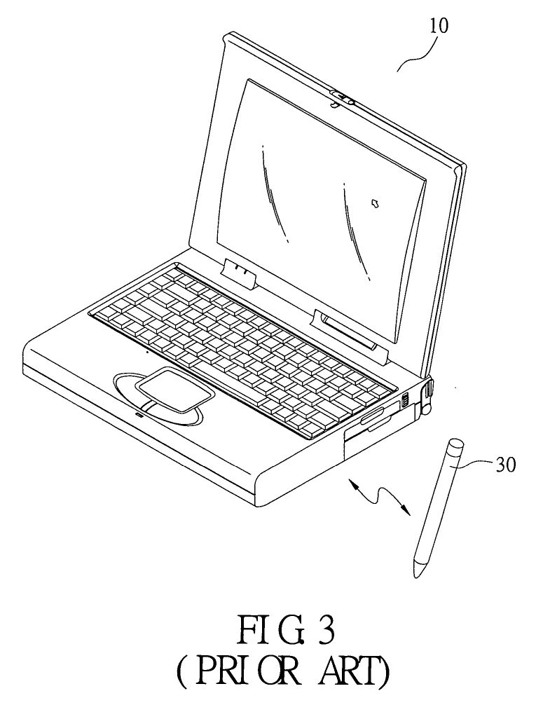

FIG. 4 schematically illustrates a wireless stylus control cursor of a conventional personal digital assistant; and

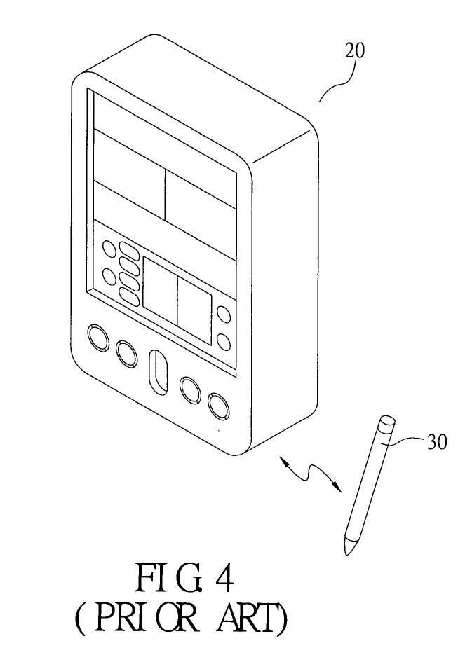

FIG. 5 is a block diagram of the present invention.

### DETAILED DESCRIPTION OF THE PREFERRED EMBODIMENTS

The following detailed description is of the best presently contemplated modes of carrying out the invention. This description is not to be taken in a limiting sense, and is made merely for the purpose of illustrating general principles of embodiments of the invention. The scope of the invention is best defined by the appended claims.

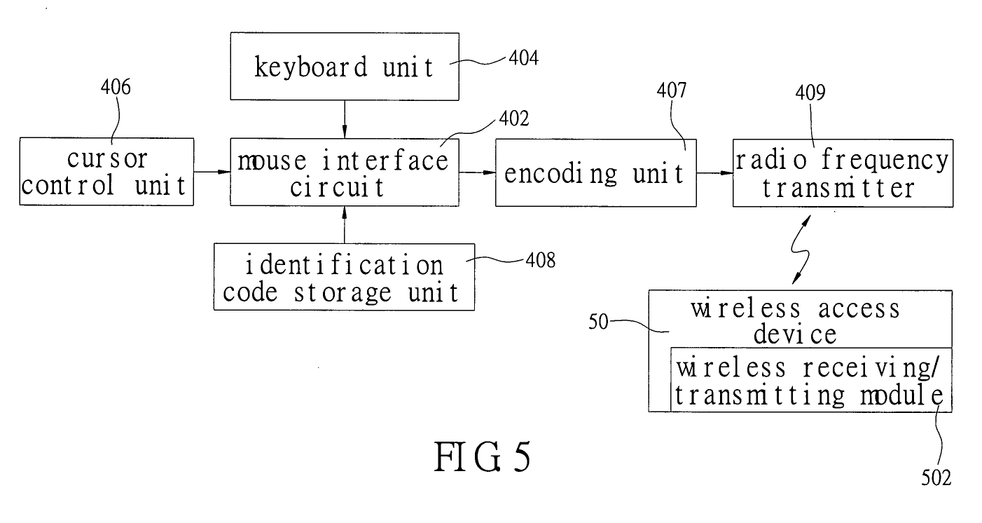

Reference is made o FIG. 5. FIG. 5 schematically illustrates a block diagram of the present invention. According to the present invention, the wireless device includes a wireless access device 50 having a wireless receiving/transmitting module 502 to receive or transmit wireless signals. The wireless access device 50 can be a notebook computer (notebook) or a personal digital assistant (PDA).

According to the present invention, the wireless device also includes a wireless stylus 40. The wireless stylus 40 includes a cursor control unit 406, an identification code storage unit 408, a mouse interface circuit 402 and a radio frequency transmitter 409. The cursor control unit 406 is used to generate a movement signal, and the identification code storage unit 408 is used to store temporarily identification code information. The mouse interface circuit 402 is electrically connected with the cursor control unit 406 and the identification code storage unit 408. Besides, the mouse interface circuit 402 is used to receive a movement signal and identification code information for output of a cursor control signal and an identification code signal by signal information processing. The radio frequency transmitter 409 is electrically connected to the mouse interface circuit 402 and used to transmit the cursor control signal and the identification code signal to the wireless access device 50 by wireless communication. In this regard, the wireless access device 50 issues a polling session to obtain the identification code of the wireless stylus 40 so as to establish wireless communication.

Further reference is made to FIG. 5. The wireless stylus 40 also includes an encoding unit 407, which is connected between the mouse interface circuit 402 and the radio frequency transmitter 409. The encoding unit 407 is used encode the cursor control signal and the identification code signal. According to the present invention, the cursor control unit 406 can be a mechanical movement sensor or an optical movement sensor. The wireless stylus 40 also has a keyboard unit 404 connected with the mouse interface circuit 402. The keyboard unit 404 outputs and transmits a key-punching signal to the mouse interface circuit 402 and to the wireless access device 50 through the radio frequency transmitter 409 by wireless communication.

Reference is made to FIG. 5 again. When the user wants to control the cursor of the wireless access device 50 by the wireless stylus 40, a recognition software is executed by the wireless access device and an identification code signal transmitted from the wireless stylus 40 is received by the wireless receiving/transmitting module 502. The identification code signal is recognized and saved. Besides, when the wireless access device 50 is in use, the recognition software issues a polling session to detect the saved identification code information so as to determine whether the wireless stylus 40 is away from the wireless access device 50.

When the wireless communication between wireless access device 50 and the wireless stylus 40 is complete, the user outputs a key-punching signal to the mouse interface circuit 402 by the keyboard unit 404. The key-punching signal is transmitted to the wireless access device 50 through the radio frequency transmitter 409. The keyboard unit 404 has a left bottom, a middle bottom and a right bottom. A scrolling wheel is positioned on the keyboard unit 404, and user can rotate and press the scrolling wheel to execute “choose”, “execute”, “scroll up/scroll down”, “turn page”, and “delete”.

After the wireless communication between wireless access device 50 and the wireless stylus 40 is complete, the user can move the wireless stylus 40 across a plane at will. A movement signal is obtained by the cursor control unit 406 and transmitted to the mouse interface circuit 402. A cursor control signal is processed and output by the mouse interface circuit 402, and transmitted to the wireless access device 50 through the radio frequency transmitter 409 by wireless communication. Thus, movement and position of the cursor is displayed.

When the wireless stylus 40 is separated from the wireless access device 50 by a long distance, the recognition software executed by the wireless access device 50 cannot detect the saved identification code information. Thus, the wireless stylus 40 is away from the wireless access device 50. The wireless access device 50 will execute the system protection program or be in the sleep mode. If the wireless stylus 40 is away from the wireless access device 50 for a long time, the wireless access device 50 will be shutdown by the recognition software.

Furthermore, when the wireless stylus 40 is positioned near the wireless access device 50 within a predetermined range, the wireless access device 50 will be awakened by the recognition software. If the wireless access device 50 is shutdown, then the user can turn on the wireless access device 50 by key-punching signal output from the keyboard unit 404.

As described above, an identification code signal with an identification code is transmitted by a wireless stylus to a wireless receiving/transmitting module of the wireless device. The identification signal is subjected to an authentication process so that the wireless device is controlled by the wireless stylus via wireless communication. Because a signal identification code is used to authenticate the wireless stylus 40 and the wireless access device 50, a plurality of wireless styluses 40 and the conventional laptop computer 10 or the conventional personal digital assistant 20 can be used at the same time. In this regard, disturbance of the transmission signal can be completely overcome.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A wireless device, comprising:
a wireless access device, having a wireless receiving/transmitting module;
a wireless stylus, comprising:
a cursor control unit, generating a movement signal;
an identification code storage unit, temporarily storing identification code information;
a mouse interface circuit, electrically connected with the cursor control unit and the identification code storage unit, wherein the mouse interface circuit receives the movement signal and the identification code information to output a cursor control signal and an identification code signal by signal information processing; and
a radio frequency transmitter, electrically connected to the mouse interface circuit and used to transmit the cursor control signal and the identification code signal to the wireless access device by wireless communication;
whereby the wireless access device issues a polling session to obtain the identification code of the wireless stylus so as to establish wireless communication.

2. The wireless device as claimed in claim 1, wherein the wireless stylus also includes an encoding unit connected between the mouse interface circuit and the radio frequency transmitter to encode the cursor control signal and the identification code signal.

3. The wireless device as claimed in claim 1, wherein the cursor control unit is a mechanical movement sensor.

4. The wireless device as claimed in claim 1, wherein the cursor control unit is an optical movement sensor.

5. The wireless device as claimed in claim 1, wherein the wireless stylus further comprises a keyboard unit connected with the mouse interface circuit, and the keyboard unit outputs and transmits a key-punching signal to the mouse interface circuit to the wireless access device through the radio frequency transmitter by wireless communication.

6. The wireless device as claimed in claim 1, wherein the wireless access device is a notebook computer.

7. The wireless device as claimed in claim 1, wherein the wireless access device is a personal digital assistant.
